(19) United States
(12) Patent Application Publication
(10) Pub. No.: US 2025/0363686 A1
(43) Pub. Date: Nov. 27, 2025

(54) FLAKING PREDICTION DEVICE, METHOD, AND PROGRAM

(71) Applicant: FUJIFILM Corporation, Tokyo (JP)

(72) Inventors: Yosuke NISHIURA, Kanagawa (JP); Koichiro NAKAMURA, Kanagawa (JP); Yuya ISHIZUKA, Kanagawa (JP)

(73) Assignee: FUJIFILM Corporation, Tokyo (JP)

(21) Appl. No.: 19/294,256

(22) Filed: Aug. 7, 2025

Related U.S. Application Data
(63) Continuation of application No. PCT/JP2023/045221, filed on Dec. 18, 2023.

(30) Foreign Application Priority Data
Feb. 13, 2023 (JP) 2023-020167

(51) Int. Cl. G06T 11/20

(52) U.S. Cl. CPC G06T 11/206

(57) ABSTRACT

A processor of a flaking prediction device is configured to, based on a plurality of pieces of three-dimensional measurement data measured for each inspection of a building, the three-dimensional measurement data being obtained by measuring a three-dimensional shape of a surface of the building, detect a bulging amount of the surface at one or more points of interest on the surface, and predict a future bulging amount of the point of interest based on a period over time of the inspection and the bulging amount for each inspection. The processor is configured to create a first graph showing a change over time in the bulging amount of the point of interest and a second graph showing a change over time in the predicted bulging amount, and output the created first graph and second graph to a display.

### CROSS-REFERENCE TO RELATED APPLICATIONS

The present application is a Continuation of PCT International Application No. PCT/JP2023/045221 filed on Dec. 18, 2023 claiming priority under 35 U.S.C § 119 (a) to Japanese Patent Application No. 2023-020167 filed on Feb. 13, 2023. Each of the above applications is hereby expressly incorporated by reference, in its entirety, into the present application.

### BACKGROUND OF THE INVENTION

### 1. Field of the Invention

The present invention relates to a flaking prediction device, method, and program, and particularly to a technique of predicting flaking of a material (concrete or the like) of a surface of a building.

### 2. Description of the Related Art

In the related art, techniques described in JP2016-006398A, JP2020-098098A, and JP2006-105680A have been proposed in order to understand floating of concrete or an internal cavity in concrete, which leads to flaking of a concrete piece.

In a flaking prediction diagnosis method described in JP2016-006398A, an infrared camera captures an infrared thermal image of a surface of a concrete building, an outside air temperature near the surface thereof is measured at the same time, a peeled portion temperature difference as a temperature difference between a sound portion and a peeled portion and a measurement temperature environment as a difference between a surface temperature of the sound portion and the outside air temperature are calculated based on the infrared thermal image and the outside air temperature, a temperature environment coefficient as a ratio of the calculated peeled portion temperature difference to the calculated measurement temperature environment is calculated, and a degree of risk of flaking of cover concrete (concrete from reinforcing bar surface to concrete surface) is quantitatively evaluated according to the temperature environment coefficient. Further, a flaking risk degree calculated at a previous time is compared with a flaking risk degree calculated at a current time to predict a flaking timing.

In an inspection method described in JP2020-098098A, a hammer for inspection device strikes a testing target, and a state of the testing target is determined based on time point history data of sound pressure generated by the strike.

In a non-destructive testing method for a concrete building described in JP2006-105680A, an ultrasonic transmitter and receiver are brought into contact with an inundated portion of the concrete building that is partially or entirely inundated, the receiver detects a resonance vibration of the concrete building while allowing a transverse wave ultrasonic wave to be incident on the concrete building from the transmitter, and a rear surface damage and/or an internal damage of the concrete building are determined based on a detection waveform of the receiver.

### SUMMARY OF THE INVENTION

In the flaking prediction diagnosis method disclosed in JP2016-006398A, since the thermal image obtained by imaging the concrete building with the infrared camera is used, it is difficult to predict the flaking with high accuracy. For example, the peeled portion has a higher or lower temperature than the sound portion under various environmental conditions, such as whether or not the building is exposed to sunlight, sunlight intensity, and the outside air temperature. Further, in a case where the infrared camera captures the thermal image, it is difficult to capture the building under the same environmental conditions as a previous time and a current time, and thus it is difficult to predict the flaking with high accuracy from the comparison between the flaking risk degree calculated at the previous time and the flaking risk degree calculated at the current time.

In a case of the inspection method described in JP2020-098098A, there is a problem that it takes a long time to determine the soundness of a large area object only by the striking sound. Further, in the non-destructive testing method for the concrete building described in JP2006-105680A, there is a need to bring the ultrasonic transmitter and receiver into contact with the inundated portion of the concrete building that is partially or entirely inundated. In JP2020-098098A and JP2006-105680A, there is no description of the prediction of the flaking of the material of the surface of the building.

One embodiment according to the technique of the present disclosure provides a flaking prediction device, method, and program capable of accurately predicting flaking of a material of a surface of a building.

An invention according to a first aspect is a flaking prediction device comprising a processor, and a memory that stores a program to be executed by the processor, in which the processor is configured to; based on a plurality of pieces of three-dimensional measurement data measured for each inspection of a building, the three-dimensional measurement data being obtained by measuring a three-dimensional shape of a surface of the building, detect a bulging amount of the surface at one or more points of interest on the surface; predict a future bulging amount of the point of interest based on a period over time of the inspection and the bulging amount for each inspection; create a first graph showing a change over time in the bulging amount of the point of interest and a second graph showing a change over time in the predicted bulging amount; and output the created first graph and second graph.

According to the first aspect of the present invention, the bulging amount of the surface at one or more points of interest on the surface is detected based on the plurality of pieces of three-dimensional measurement data measured for each inspection of the building, and the future bulging amount of the point of interest is predicted based on the period over time of the inspection and the bulging amount of the surface for each inspection. The first graph showing the change over time in the bulging amount of the point of interest and the second graph showing the change over time in the predicted bulging amount are created, and the created first and second graphs are output. A user (inspector) can understand the bulging amount (floating amount) that changes over time from the first graph and the second graph, and can also predict the timing at which the material of the surface of the building flakes off in the future. Therefore, it is possible to take measures such as giving priority to repair at a location where the timing of flaking is early.

According to a second aspect of the present invention, in the flaking prediction device according to the first aspect, it is preferable that the processor is configured to detect a floating amount of the point of interest from a difference between the bulging amount of the point of interest at an inspection start point in time and a bulging amount at a time of inspection after the inspection start point in time, and predict a future floating amount of the point of interest based on the period over time of the inspection and the floating amount for each inspection after the inspection start point in time, and the first graph shows a change over time in the floating amount of the point of interest, and the second graph shows a change over time in the predicted floating amount.

According to the second aspect of the present invention, it is possible to respectively understand, by the first graph and the second graph, the actual change over time in the floating amount of the point of interest on the surface of the building and the predicted change over time in the floating amount in the future. Accordingly, it is possible to easily distinguish between a location that bulges from a time of construction and a location (floating) that lately bulges due to rust or the like of a reinforcing bar.

According to a third aspect of the present invention, in the flaking prediction device according to the first aspect or the second aspect, it is preferable that the first graph and the second graph are continuous graphs created by different line types.

According to a fourth aspect of the present invention, in the flaking prediction device according to the second aspect, it is preferable that the processor is configured to create a flaking risk line or a flaking risk region based on a set flaking risk threshold value, and combine the flaking risk line or the flaking risk region with the first and second graphs. Accordingly, the user can understand a point in time at which the second graph exceeds the flaking risk line or a point in time at which the second graph enters the flaking risk region, as the timing of flaking in the future.

According to a fifth aspect of the present invention, in the flaking prediction device according to the second aspect, it is preferable that the processor is configured to compare the second graph with a set flaking risk threshold value to predict, as a flaking timing, a timing at which the second graph exceeds the flaking risk threshold value, and issue a notification of the flaking timing.

According to a sixth aspect of the present invention, in the flaking prediction device according to the fourth aspect or the fifth aspect, it is preferable that the processor is configured to receive the flaking risk threshold value by a user input or automatically predict the flaking risk threshold value to use the received flaking risk threshold value or the predicted flaking risk threshold value as the set flaking risk threshold value. The floating amount in a case of the flaking may be known by the user based on experience, and thus it is possible to set the flaking risk threshold value that matches the experience of the user, or set an automatically optimized flaking risk threshold value.

According to a seventh aspect of the present invention, in the flaking prediction device according to the second aspect, it is preferable that the processor is configured to create a surface property image that visualizes a size of the floating amount of the surface based on the floating amount at an inspection point in time of the surface of the building, display the surface property image on a display, and in a case where any position on the surface property image displayed on the display is received as the point of interest by a user input, display the first and second graphs, which are created corresponding to the received point of interest, on the display.

According to the seventh aspect of the present invention, the user can easily issue an instruction of an interested point of interest, and the user can understand the change over time in the floating amount of the point of interest, the timing of flaking in the future, and the like with the display, on the display, of the first and second graphs created in correspondence with the point of interest by the user instruction.

According to an eighth aspect of the present invention, in the flaking prediction device according to the seventh aspect, it is preferable that the surface property image is an image having regions with different brightness or colors in accordance with the floating amount or a contour diagram in accordance with the floating amount.

According to a ninth aspect of the present invention, in the flaking prediction device according to the first aspect, it is preferable that the three-dimensional measurement data is measured by a LiDAR or a stereo camera.

According to a tenth aspect of the present invention, in the flaking prediction device according to the first aspect, it is preferable that the three-dimensional measurement data is measured by a frequency modulated continuous wave (FMCW) type LiDAR. Accordingly, it is possible to detect the floating amount that cannot be visually checked.

According to an eleventh aspect of the present invention, in the flaking prediction device according to the first aspect, it is preferable that the plurality of pieces of three-dimensional measurement data are adjusted such that the plurality of pieces of three-dimensional measurement data at the same position on the surface of the building, where the bulging amount is not changed, match with each other. This is for accurately detecting a location where the bulging amount is changed, with the registration of the plurality of pieces of three-dimensional measurement data measured for each inspection.

According to a twelfth aspect of the present invention, in the flaking prediction device according to the first aspect, it is preferable that a material of the surface of the building includes concrete or a concrete repair material.

An invention according to a thirteenth aspect is a flaking prediction method of predicting flaking of a surface of a building, the flaking prediction method executed by a processor comprising; based on a plurality of pieces of three-dimensional measurement data measured for each inspection of the building, the three-dimensional measurement data being obtained by measuring a three-dimensional shape of the surface of the building, a step of detecting a bulging amount of the surface at one or more points of interest on the surface; a step of predicting a future bulging amount of the point of interest based on a period over time of the inspection and the bulging amount for each inspection; a step of creating a first graph showing a change over time in the bulging amount of the point of interest and a second graph showing a change over time in the predicted bulging amount; and a step of outputting the created first graph and second graph.

According to a fourteenth aspect of the present invention, it is preferable that the flaking prediction method executed by the processor according to the thirteenth aspect further comprises a step of detecting a floating amount of the point of interest from a difference between the bulging amount of the point of interest at an inspection start point in time and a bulging amount at a time of inspection after the inspection start point in time, and a step of predicting a future floating amount of the point of interest based on the period over time of the inspection and the floating amount for each inspection after the inspection start point in time, in which the first graph shows a change over time in the floating amount of the point of interest, and the second graph shows a change over time in the predicted floating amount.

According to a fifteenth aspect of the present invention, it is preferable that the flaking prediction method executed by the processor according to the fourteenth aspect further comprises a step of creating a flaking risk line or a flaking risk region based on a set flaking risk threshold value, and a step of combining the flaking risk line or the flaking risk region with the first and second graphs.

According to a sixteenth aspect of the present invention, it is preferable that the flaking prediction method executed by the processor according to the fourteenth aspect further comprises a step of comparing the second graph with a set flaking risk threshold value to predict, as a flaking timing, a timing at which the second graph exceeds the flaking risk threshold value, and a step of issuing a notification of the flaking timing.

An invention according to a seventeenth aspect is a flaking prediction program causing a computer to execute; based on a plurality of pieces of three-dimensional measurement data measured for each inspection of a building, the three-dimensional measurement data being obtained by measuring a three-dimensional shape of a surface of the building, a function of detecting a bulging amount of the surface at one or more points of interest on the surface; a function of predicting a future bulging amount of the point of interest based on a period over time of the inspection and the bulging amount for each inspection; a function of creating a first graph showing a change over time in the bulging amount of the point of interest and a second graph showing a change over time in the predicted bulging amount; and a function of outputting the created first graph and second graph.

According to the present invention, it is possible to accurately predict the flaking of the material of the surface of the building.

### BRIEF DESCRIPTION OF THE DRAWINGS

FIG. 1 is a graph showing a relationship between a lapse of time after construction of a building and a surface displacement of the building, and are diagrams showing an example of a cross section of the building at each time of inspection.

FIG. 2 is a schematic diagram of an inspection system of the building including a flaking prediction device according to the present invention.

FIG. 3 is an external view including an FMCW type LiDAR of one embodiment of a three-dimensional measurement device.

FIG. 4 is a diagram showing an embodiment in which a stereo camera measures a three-dimensional shape of a surface of the building.

FIG. 5 is a cross-sectional view of the vicinity of the surface of the building, which show an example of a mechanism in which the surface of the building is peeled off.

FIG. 6 is a cross-sectional view of the vicinity of the surface of the building, which show another example of the mechanism in which the surface of the building is peeled off.

FIG. 7 is a block diagram showing an embodiment of a hardware configuration of the flaking prediction device according to the present invention.

FIGS. 8A to 8D are diagrams showing a method of specifying bulging and floating of the surface of the building.

FIG. 9 is a diagram showing an example of a surface property image displayed on a display.

FIG. 10 is a first graph and a second graph showing a bulging amount of a surface of a point of interest of the building that changes over time.

FIG. 11 is a first graph and a second graph showing a floating amount of a surface of a point of interest of the building that changes over time.

FIG. 12 is a first graph and a second graph showing a rate of change in the floating amount of the surface of the point of interest of the building that changes over time.

FIG. 13 is a flowchart showing an embodiment of a flaking prediction method according to the present invention.

### DESCRIPTION OF THE PREFERRED EMBODIMENTS

Hereinafter, preferred embodiments of a flaking prediction device, method, and program according to the present invention will be described with reference to accompanying drawings.

### [Outline of Present Invention]

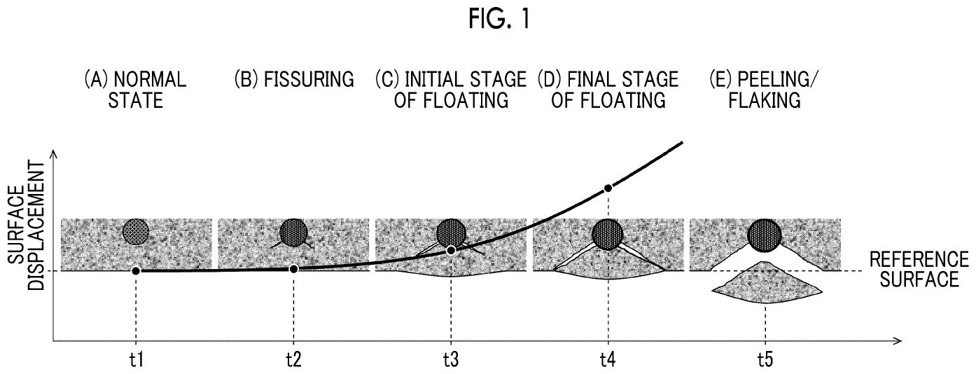

FIG. 1 is a graph showing a relationship between a lapse of time after construction of a building and a surface displacement of the building, and are diagrams showing an example of a cross section of the building at each time of inspection.

In FIG. 1, the displacement of the surface of the building is measured at an inspection start point in time (measurement start point in time at the time of construction) t1 and at each inspection point in time (t2, t3, t4, t5, . . . ) after the measurement start point in time. With a comparison between the displacements at the same position on a surface of the building, it is possible to observe a location where the surface bulges with a lapse of time from the construction of the building.

In the example shown in FIG. 1, the building at the measurement start point in time t1 is in an (A) normal state, but the surface slightly bulges due to a deterioration phenomenon ((B) fissuring) of the building at the inspection point in time t2. The bulging at this timing is not able to be checked by visual observation or the like. The “fissuring” is often caused by corrosion and thickening of a steel material (reinforcing bar) inside the building.

In a (C) initial stage of floating shown at the inspection point in time t3, the “fissuring” also progresses as the corrosion of the reinforcing bar progresses, and the surface of the building bulges (“floating” occurs).

In a (D) final stage of floating shown at the inspection point in time t4, the “fissuring” further progresses and reaches the surface of the building, and the “floating” also further increases.

The inspection point in time t5 indicates a point in time at which cover concrete (concrete from reinforcing bar surface to concrete surface) falls ((E) peeling/flaking).

In the example shown in FIG. 1, it can be seen that the displacement (bulging amount) of the surface of the building measured for each inspection gradually increases, and the cover concrete peels off and flakes off.

In addition to the deterioration of the reinforcing bar due to the corrosion of the reinforcing bar, the deterioration phenomenon of the building includes deterioration of concrete strength and concrete deterioration such as the fissuring and surface deterioration. Since the surface of the building bulges in all the deterioration phenomena, it is possible to predict a peeling/flaking timing, regardless of the cause of deterioration, from the change over time in the bulging amount of the surface.

Further, in a case where the peeling/flaking timing is predictable, it is possible to make an appropriate repair plan.

In the present invention, the bulging amounts of the surface of the building at one or more points of interest on the surface thereof are detected based on a plurality of pieces of three-dimensional measurement data measured for each inspection of the building, future bulging amounts of the points of interest are predicted based on a period over time of the inspection and the bulging amounts for each inspection, a first graph showing the change over time in the bulging amounts of the points of interest and a second graph showing the change over time in the predicted bulging amounts are created, and the created first and second graphs are output.

### [Outline Configuration of Inspection System]

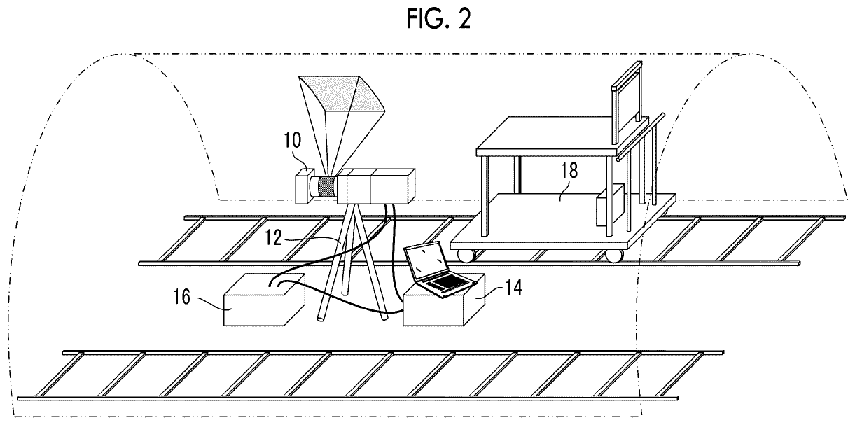

FIG. 2 is a schematic diagram of an inspection system of the building including the flaking prediction device according to the embodiment of the present invention.

The inspection system shown in FIG. 2 inspects a tunnel of a railroad, and comprises a three-dimensional measurement device 10, a data processing apparatus 14, and a power supply device 16.

The three-dimensional measurement device 10 is mounted on a tripod 12, but may be mounted on a carriage 18 that travels on a railroad track.

The three-dimensional measurement device 10 is a light detection and ranging (LiDAR) in the present example, and is particularly a frequency modulated continuous wave (FMCW) type LiDAR capable of performing distance measurement in an order of several hundred μm. However, the present invention is not limited to a case where distance measurement data (three-dimensional measurement data) measured by the FMCW type LiDAR is used.

### [Three-Dimensional Measurement Device]

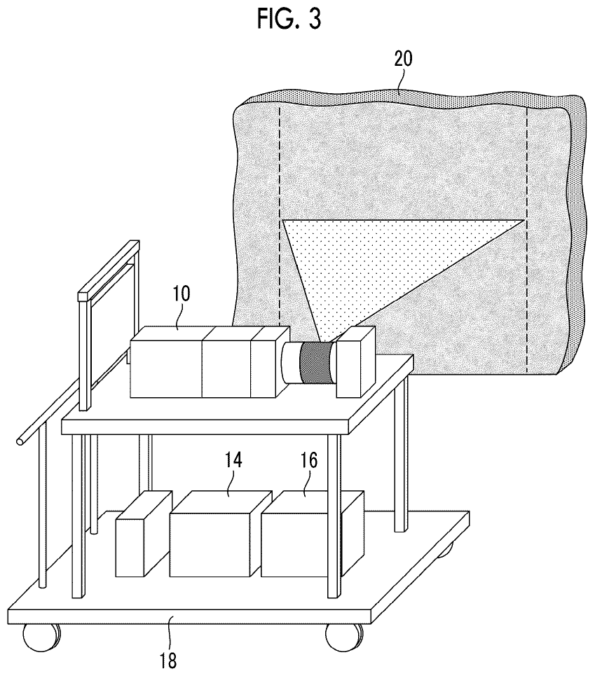

FIG. 3 is an external view including the FMCW type LiDAR of one embodiment of the three-dimensional measurement device.

In FIG. 3, the three-dimensional measurement device 10 is mounted on the carriage 18 that travels on the railroad track as shown in FIG. 2 to measure a distance to a surface of the tunnel, which is a railroad structure.

The carriage 18 is mounted with the data processing apparatus 14 and the power supply device 16, in addition to the three-dimensional measurement device 10. The power supply device 16 supplies power to the three-dimensional measurement device 10 and the data processing apparatus 14.

The three-dimensional measurement device 10 measures a distance to a wall surface (surface) 20 of the tunnel to acquire the three-dimensional measurement data indicating a shape of the wall surface 20 of the tunnel.

In the example shown in FIG. 3, the three-dimensional measurement device 10 scans the wall surface 20 in a left-right direction (main scanning direction) at a high speed with laser light of the FMCW type and causes a scanning line to move in an up-down direction (sub-scanning direction) of the wall surface 20 to perform the scanning. Accordingly, the distance measurement is performed from a measurement head of the three-dimensional measurement device 10 to a large number of measurement points on each scanning line of the laser light. Three-dimensional data of a polar coordinate system consisting of an irradiation direction of the laser light and a measured distance is converted into three-dimensional data of a rectangular coordinate system to acquire three-dimensional measurement data indicating the shape of the wall surface 20. In the present example, the three-dimensional measurement data (point group data) of a large number of measurement points is acquired as the three-dimensional measurement data.

It is considered that the three-dimensional measurement device 10 performs measurement of a minute uneven shape of the wall surface 20 under the following conditions.
Measurement accuracy: 50 μm
Measurement distance: 2 to 7 m
Measurement speed: 10 m²/sec in terms of area (speed of laser light is equivalent to 4,000 rpm)

Further, for example, the three-dimensional measurement device 10 acquires the three-dimensional data of the wall surface 20 at a constant interval during the movement of the carriage 18. However, the three-dimensional data is preferably acquired such that measurement regions of the three-dimensional data acquired at each interval partially overlap. This is for panorama composition of the three-dimensional data acquired at each interval.

The three-dimensional measurement device 10 can achieve the measurement accuracy and the like described above with the use of the FMCW type LiDAR, but the conditions such as the measurement accuracy of the three-dimensional measurement data required in the present invention are not limited to the above example. Various types of three-dimensional measurement devices can be employed without being limited to the FMCW type LiDAR.

For example, a time of flight (TOF) type LiDAR that measures a flight time of pulse-projected light to measure the distance to the wall surface 20 can be used instead of the FMCW type LiDAR. Further, the three-dimensional shape of the wall surface 20 can be measured by a stereo camera.

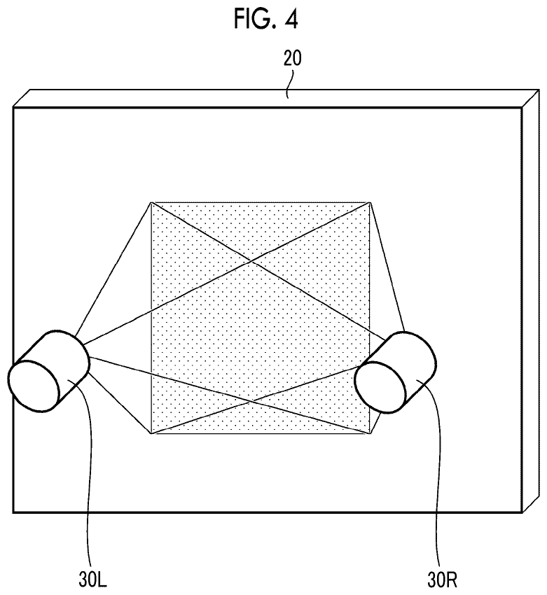

FIG. 4 is a diagram showing an embodiment in which a stereo camera measures three-dimensional shape of the surface of the building.

The stereo camera shown in FIG. 4 consists of a left camera 30L and a right camera 30R, and measures the distance to the wall surface 20 of an imaging target by a triangulation method.

In addition, various three-dimensional measurement devices, such as a laser radar three-dimensional shape measurement device described in JP1997-297014A (JP-H9-297014A) and a measurement device using an optical cutting method with an imaging device and a slit laser light projector described in JP2021-2016-31249A, can be employed as the three-dimensional measurement device that measures the distance to the wall surface 20 (that is, three-dimensional measurement data of wall surface).

The three-dimensional shape of the wall surface 20 of the tunnel is measured by the three-dimensional measurement device 10 at a time of measurement start (construction) of the tunnel and at a time of regular inspection after the construction. The measured three-dimensional measurement data of the wall surface is stored in a storage device in the data processing apparatus 14 or an external storage device at the time of measurement start and at the time of regular inspection.

### [Peeling Mechanism of Surface Material of Building]

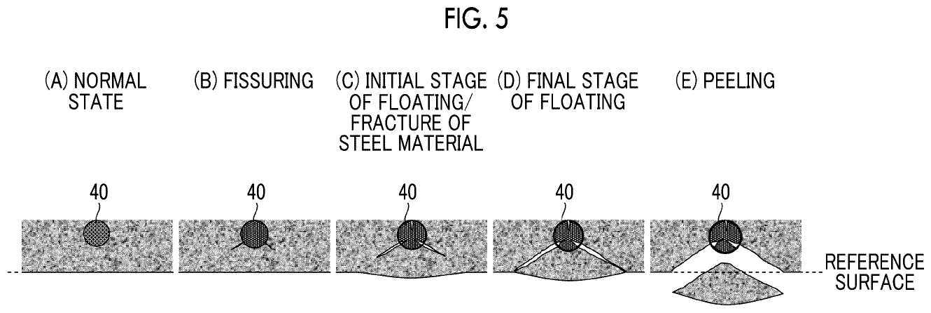

FIG. 5 is a cross-sectional view of the vicinity of the surface of the building, which show an example of a mechanism in which the surface of the building is peeled off.

The “(A) normal state” of FIG. 5 refers to a state of being normal, for example, at the time of construction of the building. The surface in this state is defined as a reference surface. In FIG. 5, 40 is a steel material (reinforcing bar).

The “(B) fissuring”, “(C) initial stage of floating/fracture of steel material”, “(D) final stage of floating”, and “(D) peeling” of FIG. 5 occur due to the corrosion (for example, salt damage or water leakage) of the reinforcing bar 40 or the like, and occur according to the number of years elapsed since the time of construction of the tunnel.

In “(C) Initial stage of floating/fracture of steel material” of FIG. 5 and subsequent stages, the surface of the building is gradually higher than the reference surface (“floating” occurs), and the cover concrete is peeled off.

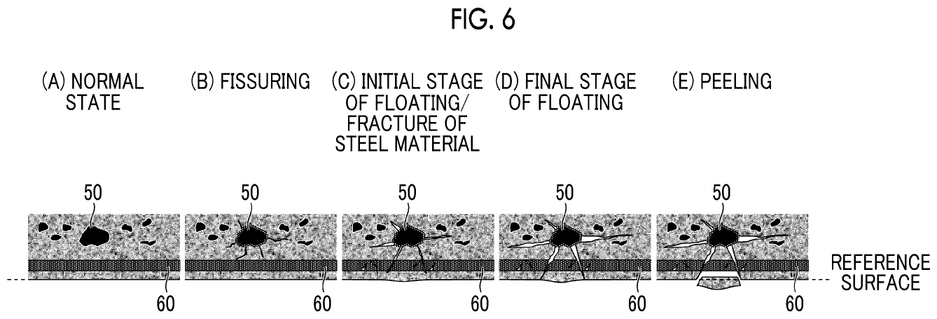

FIG. 6 is a cross-sectional view of the vicinity of the surface of the building, which show another example of the mechanism in which the surface of the building is peeled off.

The “(A) normal state” of FIG. 6 refers to a state of being normal, for example, at the time of construction of the building. The surface in this state is defined as a reference surface. In FIG. 6, 50 indicates a reactive aggregate, and 60 indicates a steel material.

The “(B) fissuring”, “(C) initial stage of floating/fracture of steel material”, “(D) final stage of floating”, and “(D) peeling” of FIG. 6 occur due to the deterioration of concrete strength (for example, alkali reaction of the reactive aggregate 50) or the like, and occur according to the number of years elapsed since the time of construction.

In “(C) Initial stage of floating/fracture of steel material” of FIG. 6 and subsequent stages, the surface of the building is gradually higher than the reference surface (“floating” occurs), and the cover concrete from a surface of the steel material 60 to the surface is peeled off.

As shown in FIG. 5 and FIG. 6, in a case where “floating” occurs due to the change over time in the surface of the building, “peeling” occurs in the future. This applies to all cases regardless of the cause of “floating”. That is, the presence or absence, material, and shape of the reinforcing bar, a material and shape of the concrete, an insertion method of the reinforcing bar into the concrete, a construction method, and a cause of corrosion (neutralization, frost damage, construction defects, or the like) are not taken into account.

### [Hardware Configuration of Flaking Prediction Device]

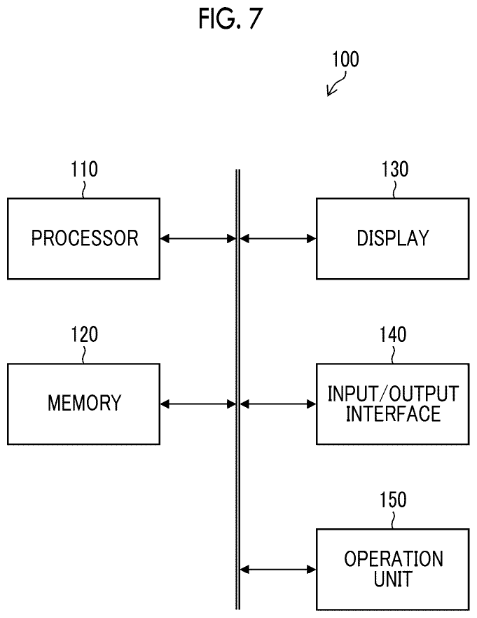

FIG. 7 is a block diagram showing an embodiment of a hardware configuration of the flaking prediction device according to the embodiment of the present invention.

A flaking prediction device 100 shown in FIG. 7 is configured of, for example, a personal computer, a workstation, or the like, and comprises a processor 110, a memory 120, a display 130, an input/output interface 140, and an operation unit 150. The flaking prediction device 100 can be incorporated as one function of the data processing apparatus 14 shown in FIG. 2.

The processor 110 is configured of a central processing unit (CPU) and the like, and integrally controls each unit of the flaking prediction device 100 and executes a flaking prediction program to execute various types of processing for predicting flaking of the surface of the building. Details of various types of processing performed by the processor 110 will be described below.

The memory 120 includes a flash memory, a read-only memory (ROM), a random access memory (RAM), a hard disk device, and the like. The flash memory, the ROM, or the hard disk device is a non-volatile memory that stores an operating system, various programs including the flaking prediction program according to the embodiment of the present invention, and the like. Further, the non-volatile memory (storage device), such as the flash memory and the hard disk device, stores the three-dimensional measurement data of the surface of the building, which is measured by the three-dimensional measurement device 10 at the time of measurement start of the building and at the time of regular inspection, together with a measurement point in time.

The RAM functions as a work area for processing by the processor 110. Further, various programs stored in the flash memory or the like, the three-dimensional measurement data of the surface of the building, and the like are temporarily stored. A part (RAM) of the memory 120 may be built into the processor 110.

The display 130 displays a screen for operation of the flaking prediction device 100, displays a graph created by the flaking prediction device 100, displays a surface property image or the like of the building, and is also used as a part of a graphical user interface (GUI) in a case where a user input of the point of interest on the surface of the building is received from the operation unit 150.

The input/output interface 140 includes a connection unit that is connectable to an external device, a communication unit that is connectable to a network, and the like. A universal serial bus (USB), a high-definition multimedia interface (HDMI) (HDMI is a registered trademark), or the like can be employed as the connection unit that is connectable to the external device.

The flaking prediction device 100 can be configured as a device independent of the data processing apparatus 14. In this case, the processor 110 can acquire the three-dimensional measurement data of the surface of the building from the data processing apparatus 14 via the input/output interface 140. Alternatively, in a case where the three-dimensional measurement data is stored in the cloud, the three-dimensional measurement data of the surface of the building can be acquired from the cloud via the input/output interface 140. Further, the processor 110 can store the three-dimensional measurement data acquired in this manner in the memory 120.

The operation unit 150 includes a pointing device such as a mouse, a keyboard, and the like, and uses the display screen of the display 130 to function as a part of the GUI that receives an instruction input by a user operation.

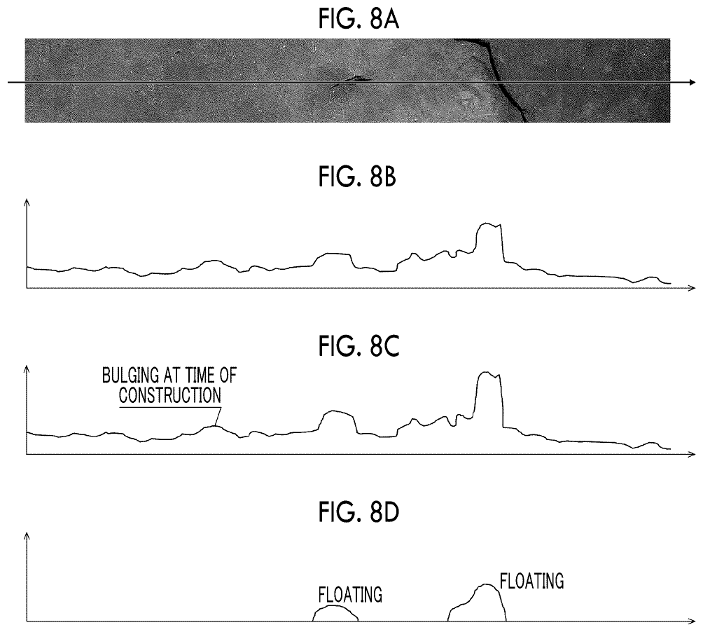

FIGS. 8A to 8D are diagrams showing a method of specifying the bulging and floating of the surface of the building.

FIG. 8A is a diagram showing a surface of the building and a scanning line of laser light that scans the surface.

The three-dimensional measurement device 10 acquires the three-dimensional measurement data (point group data) of a large number of measurement points on the scanning line of the laser light.

The processor 110 calculates, as a height of the surface of the building, a distance of the point group data in a normal direction of the reference surface with respect to the reference surface shown in FIG. 5 and the like. The reference surface can be defined as appropriate.

FIG. 8B is a waveform diagram showing the height of the surface of the building obtained from the point group data on the scanning line.

FIG. 8C is a waveform diagram showing a height of the surface of the building obtained from the point group data on the same scanning line, which is measured after the inspection start point in time of the surface of the building shown in FIG. 8B.

FIG. 8D is a waveform diagram showing a difference obtained by subtracting the waveform showing the height of the surface shown in FIG. 8B from the waveform showing the height of the surface shown in FIG. 8C.

The waveform shown in FIG. 8D is a waveform diagram showing a change amount (floating) of the surface, which changes over time between respective measurement points in time in the surface of the building shown in FIGS. 8B and 8C.

Therefore, in FIG. 8D, a portion that does not appear as “floating” is a portion where there is no change over time in the height of the surface. A location where there is no change over time and the height of the surface is convex can be regarded as a bulging portion from the time of construction (refer to FIG. 8B).

It is preferable that the plurality of pieces of three-dimensional measurement data at respective measurement points in time of the surface of the building are adjusted such that the plurality of pieces of three-dimensional measurement data at the same position on the surface of the building, where the bulging amount is not changed, match with each other. Accordingly, as shown in FIG. 8D, a floating amount, which is a difference in the bulging amount at the position where the bulging amount is not changed, can be set to zero (that is, the three-dimensional measurement data can be matched).

The processor 110 creates the surface property image that visualizes a size of the bulging amount of the surface based on, for example, the three-dimensional measurement data (point group data) of the surface of the building acquired at a time of latest inspection.

The processor 110 displays the created surface property image on the display 130.

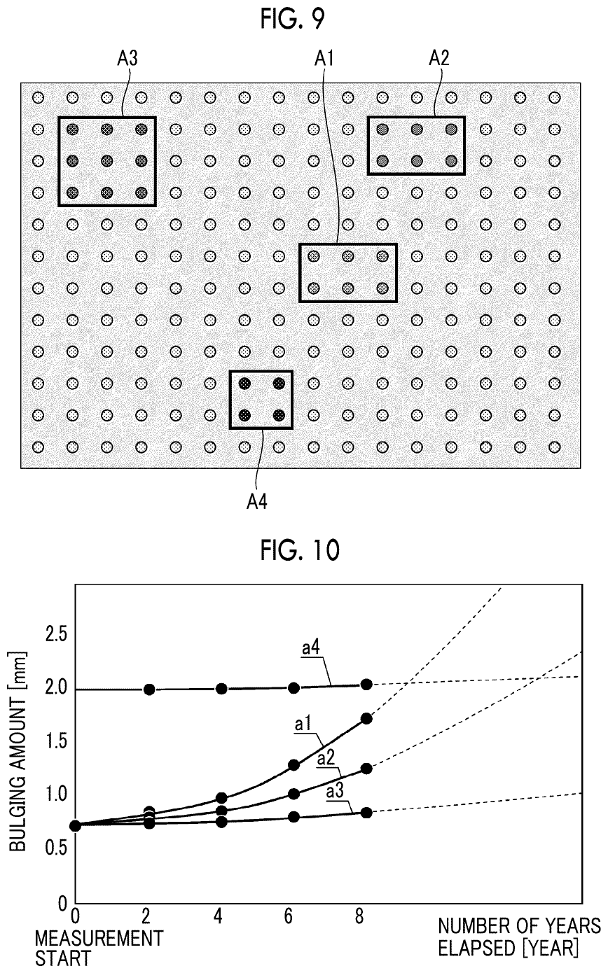

FIG. 9 is a diagram showing an example of the surface property image displayed on a display.

The surface property image shown in FIG. 9 is configured of a plurality of points uniformly distributed on the surface of the building. Each point of the image is configured of brightness data or color data in which brightness or color is different according to the size of the bulging amount at each point.

Therefore, the surface property image displayed on the display 130 is configured of the plurality of points uniformly distributed on the surface of the building, and each point of the surface property image has a region (point region) in which the brightness or color is different according to the size of the bulging amount at a position of each point.

In FIG. 9, images of points included in frames A1 to A4 have different brightness or colors from the image of points in the other region. Accordingly, a user can recognize that the bulging amounts at positions of the points included in the frames A1 to A4 are large compared with the bulging amount at positions of the points in the other region.

Here, a case will be described in which the user inputs, by the operation unit 150, any position (point position in the present example) on the surface property image displayed on the display 130, as the point of interest.

In the embodiment shown in FIG. 9, the surface property image displayed on the display 130 is configured of the plurality of points uniformly distributed on the surface of the building, but the present invention is not limited thereto. For example, a heat map, a shading image, or a contour diagram in accordance with the bulging amount of the surface of the building can be employed. Further, instead of the bulging amount of the surface of the building, the surface property image in accordance with the floating amount may be created.

In a case where any position on the surface property image displayed on the display 130 is received by the user input as the point of interest, the processor 110 creates a graph corresponding to the received point of interest.

### <Generation and Display of Graph>

The processor 110 detects the bulging amount based on the three-dimensional measurement data at the position of the point of interest for which the user input is received, among the three-dimensional measurement data of the building measured at the time of measurement start of the building and at the time of regular inspection.

Subsequently, the processor 110 predicts the future bulging amount of the point of interest based on the period over time of the inspection and the bulging amount for each inspection. A graph (first graph) showing the change over time in the measured bulging amount of the point of interest and a graph (second graph) showing the change over time in the predicted bulging amount of the point of interest are created.

FIG. 10 is the first graph and the second graph showing the bulging amount of the point of interest of the building that changes over time.

In FIG. 10, for a graph a1, in a case where the user inputs a position of any point in the frame A1 as the point of interest on FIG. 9, the processor 110 plots a point indicating the bulging amount of the surface corresponding to the point of interest at the time of measurement start (0 years) and points indicating the bulging amounts of the surface at the time of regular inspection of the number of years elapsed of 2 years, 4 years, 6 years, and 8 years and connects respective plotted points to create the first graph showing the change over time in the measured bulging amount of the surface of the point of interest. The processor 110 predicts the future bulging amount from the bulging amount of the surface corresponding to the point of interest at the time of measurement start and the bulging amount of the surface at each inspection to create the second graph showing the change over time in the predicted bulging amount.

In a case where respective plotted points are (N+1) discrete points, for example, the first graph can be an N-th spline curve that smoothly connects the (N+1) discrete points, and the second graph can be a graph on the spline curve.

In a case where the first and second graphs are created, the processor 110 outputs the first graph and the second graph to the display 130. The first graph and the second graph are continuous graphs created by different line types. In the example shown in FIG. 10, the first graph showing the change over time in the measured bulging amount of the surface of the point of interest is displayed by a solid line, the second graph showing the change over time in the predicted bulging amount is displayed by a dotted line, and the user can distinguish between the first graph and the second graph by the difference in the line types between the first graph and the second graph.

In FIG. 10, four graphs a1 to a4 are shown. In a case where the user inputs the position of any point in the frame A1 as the point of interest on FIG. 9, only the graph a1 is displayed on the display 130. Further, in a case where the user inputs a position of any point in the frame A2 as the point of interest on FIG. 9, the processor 110 plots points indicating the bulging amounts at the time of measurement start and at the time of regular inspection corresponding to the point of interest, creates the first and second graphs based on respective plotted points, and displays the graph a2 on the display 130. Similarly, in a case where the user inputs a position of any point in the frame A3 as the point of interest on FIG. 9, or in a case where the user inputs a position of any point in the frame A4 as the point of interest on FIG. 9, the processor 110 displays the graph a3 or the graph a4 on the display 130.

In the above embodiment, the first graph showing the change over time in the measured bulging amount of the surface of the point of interest and the second graph showing the change over time in the predicted bulging amount are created and displayed on the display 130. However, the first graph showing the change over time in the measured floating amount of the surface of the point of interest and the second graph showing the change over time in the predicted floating amount may be created and displayed on the display 130.

As described with reference to FIGS. 8A to 8D, it is possible to calculate the “floating amount” by the difference obtained by subtracting, from the bulging amount measured at each time of inspection, the bulging amount at the time of measurement start at the same position.

The processor 110 can create the first graph showing the change over time in the “floating amount” calculated in this manner and the second graph showing the change over time in the predicted “floating amount”, and display the created first and second graphs on the display 130.

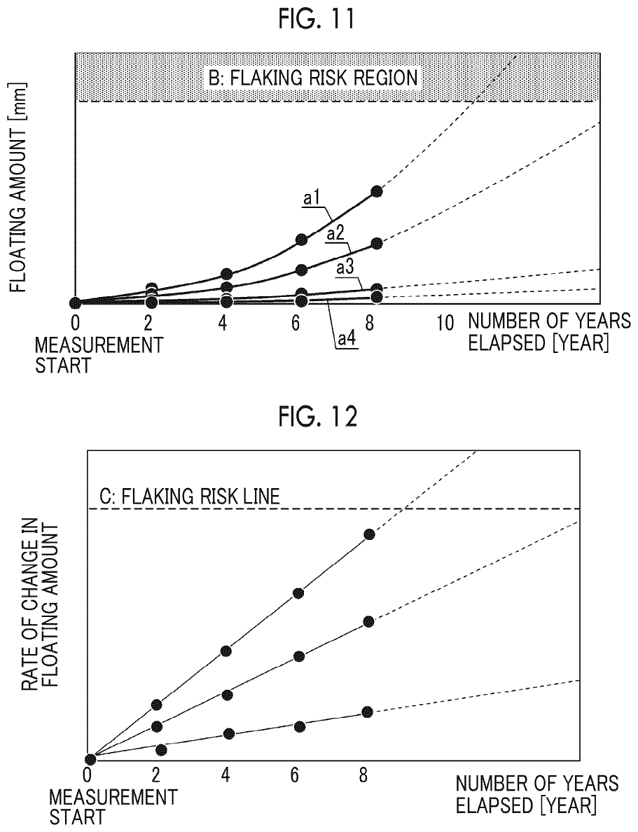

FIG. 11 is a first graph and a second graph showing the floating amount of the surface of the point of interest of the building that changes over time.

In FIG. 11, four graphs a1 to a4 are shown. As in the case shown in FIG. 10, in response to an instruction, which is issued by the user, of a point of interest in any frame among the frames A1 to A4 shown in FIG. 9, the first graph and the second graph corresponding to the change over time in the floating amount at the instructed point of interest are created and displayed on the display 130.

In FIG. 11, the floating amount of the building at the time of measurement start is zero. Thereafter, the floating amount increases according to the deterioration of the building with the number of years elapsed.

Further, FIG. 11 shows a flaking risk region B. The processor 110 creates the flaking risk region B based on a set flaking risk threshold value, combines the created flaking risk region with the first and second graphs in a visible manner, and displays the combined region and graphs on the display 130.

The flaking risk threshold value may be randomly set by the user using the operation unit 150.

The floating amount of flaking off may be known by the user based on experience, and the flaking risk threshold value suitable for the experience of the user can be set.

Further, the flaking risk threshold value may be automatically predicted, and the predicted flaking risk threshold value may be used as the set flaking risk threshold value. It is considered that the flaking risk threshold value is predicted by regression analysis using statistical data including the floating amount in a case of flaking in the past, and by using an image and artificial intelligence (AI).

The flaking risk region B shown in FIG. 11 is a region of the floating amount exceeding the set flaking risk threshold value.

With the example shown in FIG. 11, the points of interest corresponding to the graphs a1 and a2 can be determined to be malignant floating in which the floating amount progresses fast, and the timing of flaking (flaking timing at which the second graph exceeds the flaking risk threshold value) can also be predicted. It is preferable to prioritize the repair of such malignant floating at an early stage where a function of the building is not impaired. On the other hand, the points of interest corresponding to the graphs a3 and a4 can be determined to be benign floating in which the floating amount progresses slowly.

Further, in FIG. 11, the flaking risk region B is displayed together with the display of the graphs, but a flaking risk line indicating a set flaking risk threshold value (floating amount at lower limit of the flaking risk region B) may be displayed instead of the flaking risk region B.

FIG. 12 is a first graph and a second graph showing a rate of change in the floating amount of the surface of the point of interest of the building that changes over time.

The processor 110 can calculate an inclination (differential value) of the floating amount shown in FIG. 11 to calculate the rate of change in the floating amount. The processor 110 creates the first graph showing the change over time in “rate of change in floating amount” calculated in this manner and the second graph showing the change over time in predicted “rate of change in floating amount”, and displays the created first and second graphs on the display 130 as shown in FIG. 12.

FIG. 12 shows a flaking risk line C indicating the flaking risk threshold value. The flaking risk line C is a threshold value set as the rate of change in the floating amount indicating a risk of the peeling/flaking of the surface of the building.

The user can also predict the timing of flaking of the surface of the building by the index shown in FIG. 12.

### [Flaking Prediction Method]

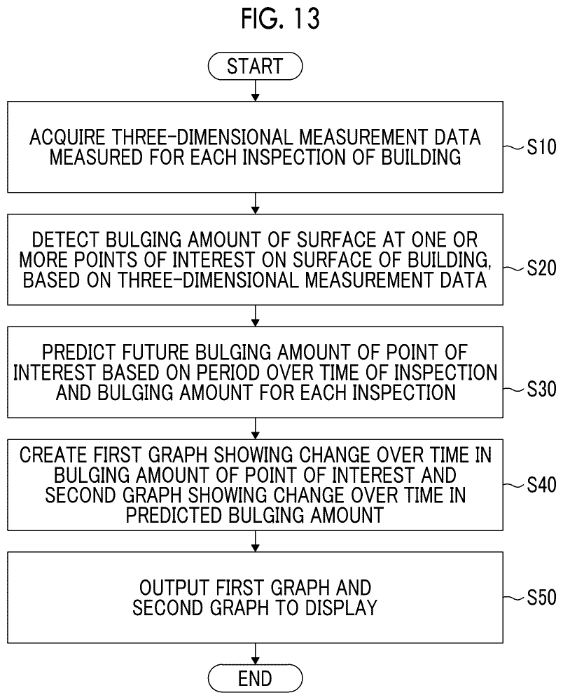

FIG. 13 is a flowchart showing an embodiment of a flaking prediction method according to the present invention.

The flaking prediction method shown in FIG. 13 is performed by the processor 110 of the flaking prediction device 100 shown in FIG. 7.

In FIG. 13, the processor 110 acquires the three-dimensional measurement data measured by the three-dimensional measurement device 10 (refer to FIG. 3) for each inspection of the building (step S10). The processor 110 may acquire the three-dimensional measurement data from the storage device of the data processing apparatus 14, the cloud, or the like, or from the memory 120 of the flaking prediction device 100.

The processor 110 detects the bulging amount from the reference surface of the surface at one or more points of interest on the surface of the building, based on the three-dimensional measurement data (step S20). The user can designate one or more points of interest on the surface of the building.

The processor 110 predicts the future bulging amount of the point of interest based on the period over time of the inspection and the bulging amount for each inspection (step S30).

The processor 110 creates the graph (first graph) showing the change over time in the measured bulging amount of the point of interest and the graph (second graph) showing the change over time in the predicted bulging amount of the point of interest (step S40).

The processor 110 outputs the created first and second graphs to the display 130 (step S50). For example, it is preferable that the first graph showing the change over time in the measured bulging amount of the point of interest is displayed by the solid line, the second graph showing the change over time in the predicted bulging amount of the point of interest is displayed by the dotted line, as shown in FIG. 10, and both graphs are displayed in a distinguishable manner.

The user can determine, from the first and second graphs, whether the point of interest is the malignant bulging in which the bulging amount progresses fast, bulges from the time of construction, or is the benign bulging in which the bulging amount progresses slowly.

### [Other]

The building of the present embodiment is the tunnel, but the present invention is not limited thereto. Any building may be employed as long as the building is subjected to inspection, such as a bridge or a dam. The material of the surface of the building includes concrete repair materials such as reinforced concrete, concrete, and mortar.

Further, the flaking prediction device displays, on the display in a visible manner, the first and second graphs showing the change over time in the bulging amount (including the floating amount, which is the difference in the bulging amount for each inspection, the rate of change in the floating amount, and the like) of the surface of the point of interest. However, the second graph may be compared with the set flaking risk threshold value to predict, as the flaking timing, the timing at which the second graph exceeds the flaking risk threshold value, and a notification of the flaking timing may be issued, in addition to the display of the first and second graphs, or separately from the first and second graphs.

In the present embodiment, for example, a hardware structure of a processing unit that executes various types of processing, such as a central processing unit (CPU), includes the following various processors. The various processors include: a CPU that is a general-purpose processor functioning as various processing units by executing software (programs); a programmable logic device (PLD) that is a processor of which the circuit configuration can be changed after manufacture, such as a field programmable gate array (FPGA); a dedicated electrical circuit that is a processor having a circuit configuration designed exclusively to perform specific processing, such as an application specific integrated circuit (ASIC); and the like.

One processing unit may be configured of one of these various processors or may be configured of two or more processors of the same type or different types (for example, a plurality of FPGAs or a combination of CPU and FPGA). Further, a plurality of processing units may be configured by one processor. As an example of configuring the plurality of processing units by one processor, first, there is a form in which one processor is configured of a combination of one or more CPUs and software, as represented by a computer such as a client or a server, and the one processor functions as the plurality of processing units. Second, there is a form in which a processor that realizes the functions of the entire system including the plurality of processing units by one integrated circuit (IC) chip is used, as represented by a system on chip (SoC) or the like. In this manner, the various processing units are configured using one or more of the various processors as the hardware structure.

Further, as the hardware structure of the various processors, more specifically, an electric circuit (circuitry) in which circuit elements such as semiconductor elements are combined may be used.

Further, the present invention includes the flaking prediction program causing a computer to function as the flaking prediction device according to the present invention by being installed in the computer, and a non-volatile storage medium in which the flaking prediction program is recorded.

It is needless to say that the present invention is not limited to the embodiments described above and various modifications can be made within a range not departing from the spirit of the present invention.

### EXPLANATION OF REFERENCES

10: three-dimensional measurement device
12: tripod
14: data processing apparatus
16: power supply device
18: carriage
20: wall surface
30L: left camera
30R: right camera
40: reinforcing bar
50: reactive aggregate
60: steel material
100: flaking prediction device
110: processor
120: memory
130: display
140: input/output interface
150: operation unit
A1 to A4: frame
B: flaking risk region
C: flaking risk line
S10 to S50: step
a1 to a4: graph

What is claimed is:

1. A flaking prediction device comprising:
a processor; and
a memory that stores a program to be executed by the processor,
wherein the processor is configured to:
based on a plurality of pieces of three-dimensional measurement data measured for each inspection of a building, the three-dimensional measurement data being obtained by measuring a three-dimensional shape of a surface of the building, detect a bulging amount of the surface at one or more points of interest on the surface;
predict a future bulging amount of the point of interest based on a period over time of the inspection and the bulging amount for each inspection;
create a first graph showing a change over time in the bulging amount of the point of interest and a second graph showing a change over time in the predicted bulging amount; and
output the created first graph and second graph.

2. The flaking prediction device according to claim 1,
wherein the processor is configured to:
detect a floating amount of the point of interest from a difference between the bulging amount of the point of interest at an inspection start point in time and a bulging amount at a time of inspection after the inspection start point in time; and
predict a future floating amount of the point of interest based on the period over time of the inspection and the floating amount for each inspection after the inspection start point in time, and
the first graph shows a change over time in the floating amount of the point of interest, and the second graph shows a change over time in the predicted floating amount.

3. The flaking prediction device according to claim 1,
wherein the first graph and the second graph are continuous graphs created by different line types.

4. The flaking prediction device according to claim 2,
wherein the processor is configured to:
create a flaking risk line or a flaking risk region based on a set flaking risk threshold value; and
combine the flaking risk line or the flaking risk region with the first and second graphs.

5. The flaking prediction device according to claim 2,
wherein the processor is configured to:
compare the second graph with a set flaking risk threshold value to predict, as a flaking timing, a timing at which the second graph exceeds the flaking risk threshold value; and
issue a notification of the flaking timing.

6. The flaking prediction device according to claim 4,
wherein the processor is configured to:
receive the flaking risk threshold value by a user input or automatically predict the flaking risk threshold value to use the received flaking risk threshold value or the predicted flaking risk threshold value as the set flaking risk threshold value.

7. The flaking prediction device according to claim 2,
wherein the processor is configured to:
create a surface property image that visualizes a size of the floating amount of the surface based on the floating amount at an inspection point in time of the surface of the building;
display the surface property image on a display; and
in a case where any position on the surface property image displayed on the display is received as the point of interest by a user input, display the first and second graphs, which are created corresponding to the received point of interest, on the display.

8. The flaking prediction device according to claim 7,
wherein the surface property image is an image having regions with different brightness or colors in accordance with the floating amount or a contour diagram in accordance with the floating amount.

9. The flaking prediction device according to claim 1,
wherein the three-dimensional measurement data is measured by a LiDAR or a stereo camera.

10. The flaking prediction device according to claim 1,
wherein the three-dimensional measurement data is measured by a frequency modulated continuous wave (FMCW) type LiDAR.

11. The flaking prediction device according to claim 1,
wherein the plurality of pieces of three-dimensional measurement data are adjusted such that the plurality of pieces of three-dimensional measurement data at the same position on the surface of the building, where the bulging amount is not changed, match with each other.

12. The flaking prediction device according to claim 1,
wherein a material of the surface of the building includes concrete or a concrete repair material.

13. A flaking prediction method of predicting flaking of a surface of a building, the flaking prediction method executed by a processor comprising:
based on a plurality of pieces of three-dimensional measurement data measured for each inspection of the building, the three-dimensional measurement data being obtained by measuring a three-dimensional shape of the surface of the building, a step of detecting a bulging amount of the surface at one or more points of interest on the surface;
a step of predicting a future bulging amount of the point of interest based on a period over time of the inspection and the bulging amount for each inspection;
a step of creating a first graph showing a change over time in the bulging amount of the point of interest and a second graph showing a change over time in the predicted bulging amount; and
a step of outputting the created first graph and second graph.

14. The flaking prediction method executed by the processor according to claim 13, further comprising:
a step of detecting a floating amount of the point of interest from a difference between the bulging amount of the point of interest at an inspection start point in time and a bulging amount at a time of inspection after the inspection start point in time; and
a step of predicting a future floating amount of the point of interest based on the period over time of the inspection and the floating amount for each inspection after the inspection start point in time,
wherein the first graph shows a change over time in the floating amount of the point of interest, and the second graph shows a change over time in the predicted floating amount.

15. The flaking prediction method executed by the processor according to claim 14, further comprising:
a step of creating a flaking risk line or a flaking risk region based on a set flaking risk threshold value; and
a step of combining the flaking risk line or the flaking risk region with the first and second graphs.

16. The flaking prediction method executed by the processor according to claim 14, further comprising:
a step of comparing the second graph with a set flaking risk threshold value to predict, as a flaking timing, a timing at which the second graph exceeds the flaking risk threshold value; and
a step of issuing a notification of the flaking timing.

17. A non-transitory, computer-readable tangible recording medium on which a program for causing, when read by a computer, a processor of the computer to execute the flaking prediction method according to claim 13 is recorded.
